(19) United States
(12) Patent Application Publication
(10) Pub. No.: US 2024/0412678 A1
(43) Pub. Date: Dec. 12, 2024

(54) ELECTRONIC APPARATUS AND CONTROL METHOD

(71) Applicant: Lenovo (Singapore) Pte. Ltd., Singapore (SG)

(72) Inventors: Yasushi Tsukamoto, Kanagawa (JP); Koji Kawakita, Kanagawa (JP); Koichiro Ishigami, Kanagawa (JP)

(73) Assignee: Lenovo (Singapore) Pte. Ltd., Singapore (SG)

(21) Appl. No.: 18/644,556

(22) Filed: Apr. 24, 2024

(30) Foreign Application Priority Data
Jun. 9, 2023 (JP) 2023-095553

(51) Int. Cl. G09G 3/20; G06F 1/16; G09G 3/3208; H04N 23/57

(52) U.S. Cl. CPC G09G 3/2092; G06F 1/1616; G06F 1/1686; G09G 3/3208; H04N 23/57; G09G 2320/045; G09G 2320/0626; G09G 2320/0686

(57) ABSTRACT

An electronic apparatus includes a display having a screen area in which a plurality of pixels is arranged, a camera, and a controller. Light transmitted through a transparent area, which is a part of the screen area, is incident on the camera. The controller restricts display at least in the transparent area when acquiring a captured image from the camera, and removes a restriction when not acquiring the captured image.

### CROSS-REFERENCE TO RELATED APPLICATIONS

This application claims priority to Japanese Patent Application No. 2023-095553 filed on Jun. 9, 2023, the contents of which are hereby incorporated herein by reference in their entirety.

### BACKGROUND

### Technical Field

The present application relates to an electronic apparatus and a control method such as, for example, an electronic apparatus having a display and a camera.

### Discussion of the Background

Some electronic apparatuses, such as clamshell-type personal computers (PCs), have a display and a camera in their chassis. In some cases, an aperture is provided in the upper center of a screen area so that the screen display is not obstructed as much as possible and a camera is provided in the aperture. Since the aperture is located outside the screen area, the screen occupancy rate is limited. In recent years, PCs with a high screen occupancy rate are preferred, and camera under display (CUD) type PCs have been put into practical use.

The CUD system has a configuration in which a camera is installed on the back side of the screen area of the display. The camera captures an image that appears in the light transmitted through the screen area. For example, Japanese Unexamined Patent Application Publication (Translation of PCT Application) No. 2022-513506 describes a display device that covers the main body of the device, has an element area located behind the display area, and includes photosensitive elements that collect light passing through the display area in the element area. The photosensitive elements include a camera.

In the CUD system, however, it is desirable to turn off the pixels placed in the area that covers the camera's optical system (sometimes referred to as “transparent area” in the present application) out of the screen area during image capture by the camera. When the screen display in the transparent area is maintained and the pixels are turned on, the light emitted by the pixels enters the optical system of the camera. Therefore, the image quality of the captured image may be significantly affected by the incident light from the pixels. For example, a captured image taken while the green pixels placed in the transparent area are turned on is entirely more greenish than a captured image taken without turning on the green pixels, and further the contrast is reduced and the edges of the image tend to be blurred.

### SUMMARY

An electronic apparatus according to a first aspect of one or more embodiments includes: a display having a screen area in which a plurality of pixels is arranged, a camera, and a controller, wherein light transmitted through a transparent area, which is a part of the screen area, is incident on the camera, wherein the controller restricts display at least in the transparent area when acquiring a captured image from the camera, and removes the restriction when not acquiring the captured image.

In the above electronic apparatus, the controller may control whether display is required at least in the transparent area at each fixed imaging cycle and may accumulate a signal value of a captured image for each non-display period included in an exposure period of the camera.

In the above electronic apparatus, the controller controls whether the display is required for the entire screen area.

In the above electronic apparatus, the controller may not control whether display is required for the standard area, which is an area surrounding the transparent area, and may set the luminance of the transparent area in the display period to be higher than the luminance of the standard area.

In the above electronic apparatus, the camera may control imaging conditions in the non-display period for the transparent area.

The above electronic apparatus may have a first chassis, a second chassis, and an engagement fixture that allows the first chassis to be rotatably engaged with the second chassis, wherein the display may be installed on a surface facing the second chassis in the first chassis and the transparent area may be installed in the center of the screen area.

A control method according to a second aspect of one or more embodiments is used in an electronic apparatus including: a display having a screen area in which a plurality of pixels is arranged, a camera, and a controller, in which light transmitted through a transparent area, which is a part of the screen area, is incident on the camera, wherein the electronic apparatus restricts display at least in the transparent area when acquiring a captured image from the camera, and removes the restriction when not acquiring the captured image.

One or more embodiments can avoid degradation in image quality of the captured image while achieving screen display in the screen area.

### BRIEF DESCRIPTION OF THE DRAWINGS

FIG. 1 is a front view illustrating an example of an external configuration of an electronic apparatus according to one or more embodiments.

FIG. 2 is a cross-sectional view illustrating a cross-section of the electronic apparatus according to one or more embodiments.

FIG. 3 is a schematic block diagram illustrating an example of a hardware configuration of the electronic apparatus according to one or more embodiments.

FIG. 4 is a schematic block diagram illustrating an example of a functional configuration of the electronic apparatus according to one or more embodiments.

FIG. 5 is an explanatory diagram illustrating an example of synchronous control of display and image capture according to one or more embodiments.

FIG. 6 is an explanatory diagram illustrating an example of acquiring an output image according to one or more embodiments.

FIG. 7 is a diagram illustrating a first example of temporal change of luminance of pixels arrayed on the display.

FIG. 8 is a diagram illustrating a second example of temporal change of luminance of pixels arrayed on the display.

FIG. 9 is a flowchart illustrating an imaging control process according to one or more embodiments.

FIG. 10 is a front view illustrating another example of the external configuration of the electronic apparatus according to one or more embodiments.

### DETAILED DESCRIPTION

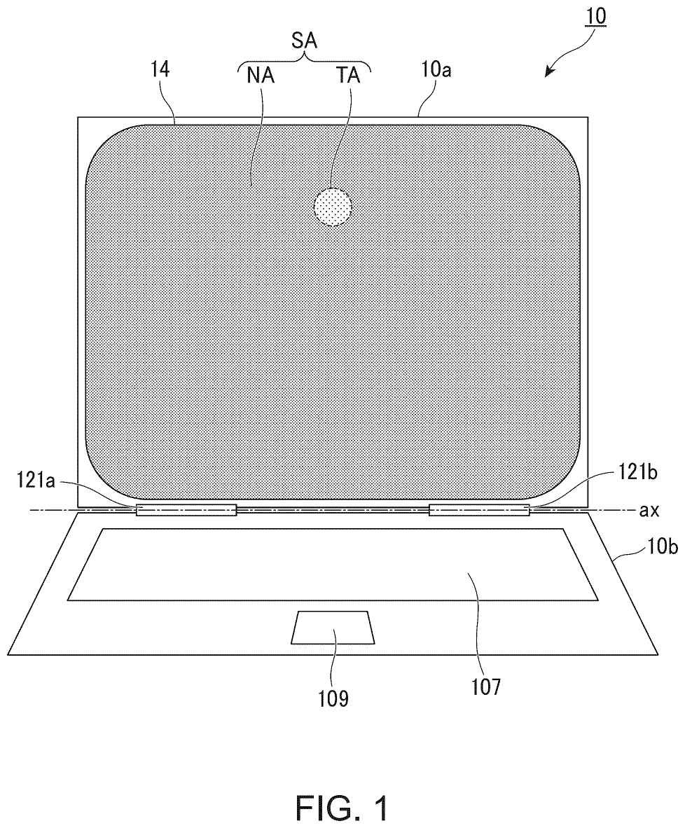

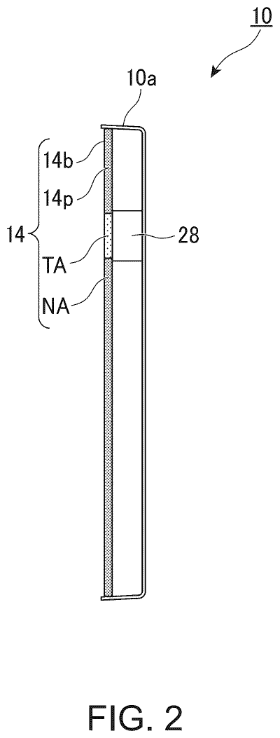

An electronic apparatus according to one or more embodiments is described below with reference to the drawings. In the following description, the case in which the electronic apparatus according to one or more embodiments is an information processing apparatus 10 configured as a clamshell-type PC is taken as an example. The clamshell-type PC is also called a notebook PC or a laptop PC. FIG. 1 is a front view illustrating an example of an external configuration of the electronic apparatus according to one or more embodiments. FIG. 2 is a cross-sectional view illustrating a cross-section of the electronic apparatus according to one or more embodiments.

The information processing apparatus 10 has a first chassis 10a and a second chassis 10b. The first chassis 10a is rotatable with respect to the second chassis 10b. An angle between the surface of the first chassis 10a and the surface of the second chassis 10b (sometimes referred to as “open-close angle” in the present application) is variable. The long sides of the first chassis 10a and the long sides of the second chassis 10b are joined together using hinge mechanisms 121a and 121b. The hinge mechanisms 121a and 121b enable the first chassis 10a to be relatively rotatable to the second chassis 10b around the rotation axis ax. The direction of the rotation axis ax is parallel to both the long side of the first chassis 10a and the long side of the second chassis 10b. The hinge mechanisms 121a and 121b are capable of maintaining an arbitrary open-close angle θ even when some torque is applied.

The first chassis 10a is box-shaped. On the surface of the first chassis 10a, a display 14 and a camera 28 are mounted. Other members are stored inside the second chassis 10b. On the surface of the second chassis 10b, a keyboard 107 and a touchpad 109 are mounted. When the first chassis 10a is open to the second chassis 10b, a user facing the front of the first chassis 10a is able to see display information appearing on the display 14 and to perform input operations with the keyboard 107 and the touchpad 109. At this time, the camera 28 is able to capture the image of a user's head. In the following description, the first chassis 10a and the second chassis 10b are sometimes collectively referred to simply as “chassis.”

The display 14 has a nearly flat shape and is configured as a display panel. The display 14 covers most of the surface of the first chassis 10a and is supported around its periphery by the first chassis 10a. The display 14 has a substrate 14b. On the substrate 14b, a plurality of pixels 14p is arranged in a two-dimensional array at regular intervals. The area where the plurality of pixels 14p is arranged forms a screen area SA. The brightness or color distribution in the screen area SA represents display information. In a transparent area TA, which is a part of the screen area SA, pixels 14p are placed more sparsely than in a normal area NA, which is the surrounding area. In the transparent area TA, adjacent pixels 14p are arrayed with a gap between them instead of touching each other completely. The incident light into the transparent area TA passes through the gaps between the pixels and enters the optical system of the camera 28. The pixel spacing in the transparent area TA may be equal to the pixel spacing in the normal area NA. In this case, the size of the pixel placed in the transparent area TA may be smaller than the size of the pixel placed in the normal area NA.

Thus, the information processing apparatus 10 has the display 14 and the camera 28. The display 14 has a screen area in which the plurality of pixels is arrayed. Light transmitted through the transparent area TA is incident on the camera 28. The transparent area TA forms a part of the screen area SA of the display 14. The information processing apparatus 10 restricts the display in the transparent area TA when acquiring a captured image from the camera 28, and removes the restriction on the display in the transparent area TA when not acquiring a captured image from the camera 28. By switching whether the display in the transparent area TA is required in a short cycle, the display information on the display 14 is visible to the user, and the captured image taken in the non-display period is not affected by the display.

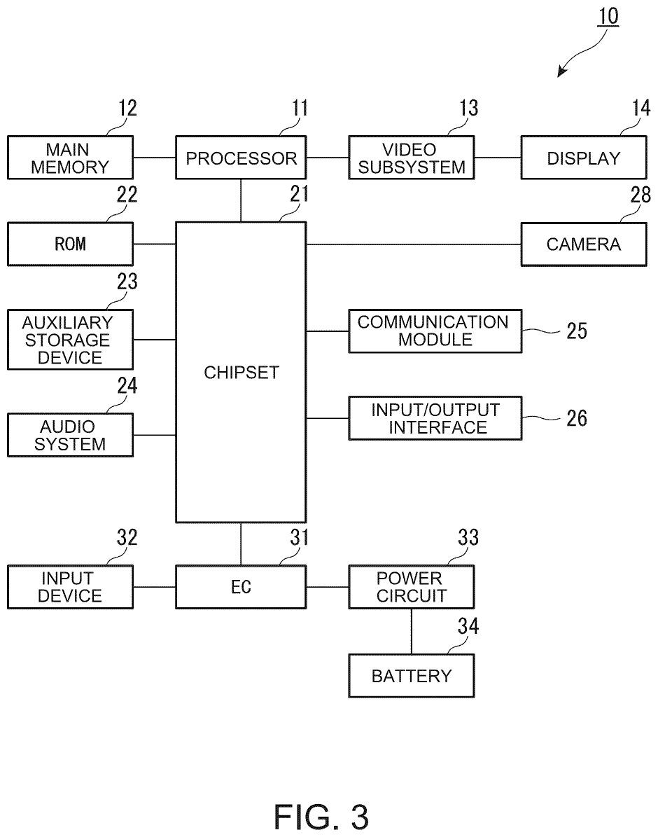

Subsequently, an example hardware configuration of the electronic apparatus according to one or more embodiments is described. FIG. 3 is a schematic block diagram illustrating an example of a hardware configuration of the electronic apparatus according to one or more embodiments. The information processing apparatus 10 includes a processor 11, a main memory 12, a video subsystem 13, a display 14, a chipset 21, a ROM 22, an auxiliary storage device 23, an audio system 24, a communication module 25, an input/output interface 26, a camera 28, an embedded controller (EC) 31, an input device 32, a power circuit 33, and a battery 34.

The processor 11 is the core processing device that performs various arithmetic operations as instructed by the instructions written in software (program). Processes performed by the processor 11 include reading and writing data from and to storage media such as the main memory 12 and the auxiliary storage device 23, and performing input and output to and from other devices. The processor 11 includes at least one CPU. The CPU controls the entire operation of the information processing apparatus 10. The CPU performs processes based on programs such as, for example, an operating system (OS), firmware, device drivers, utilities, application programs (sometimes referred to as “apps” in the present application), and the like. In the present application, performing a process as instructed by commands written in various programs is sometimes referred to as “executing a program,” “execution of a program,” and so on.

The main memory 12 is a writable memory used as a reading area of an executable program of the processor 11 or as a working area to write the processing data of the executable program. The main memory 12 is composed of, for example, a plurality of dynamic random access memory (DRAM) chips. The processor 11 and the main memory 12 correspond to the minimum hardware that makes up a host system 100 (described later). The host system 100 is a computer system that forms the core of the information processing apparatus 10.

The video subsystem 13 is a subsystem for implementing functions related to image display, and includes a video controller. The video controller processes a drawing command from the processor 11, writes obtained drawing information into the video memory, reads the drawing information from the video memory, and outputs the drawing information to the display 14 as display data representing the display information (image processing).

The display 14 displays the display information based on the display data input from the video subsystem 13. The light emitting elements provided in the display 14 are desirably made of materials that have high responsiveness to drive signals. The display 14 is, for example, an organic light emitting diode (OLED) display.

The chipset 21 has a plurality of controllers and is able to be connected to a plurality of devices for input/output of various data. The controller is any one or a combination of bus controllers for, for example, a universal serial bus (USB), serial ATA (AT attachment) bus, a serial peripheral interface (SPI) bus, a peripheral component interconnect (PCI) bus, and a PCI-Express bus, and a low pin count (LPC) bus. The plurality of devices includes, for example, the ROM 22, the auxiliary storage device 23, the audio system 24, the communication module 25, the input/output interface 26, and the EC 31.

The ROM 22 stores mainly system firmware, firmware to control the operation of the EC 31 and other devices, and the like. The ROM 22 may be, for example, an electrically erasable programmable read only memory (EEPROM) or a flash ROM.

The auxiliary storage device 23 stores various data used for processes by the processor 11 and other devices, various data and programs acquired by the processes, and the like. The auxiliary storage device 23 may be, for example, any one or a combination of a solid state drive (SSD), a hard disk drive (HDD), and the like.

The audio system 24 is connected to a microphone and a speaker (not illustrated), and performs recording, playback, and output of audio data. The microphone and speaker may be built into the information processing apparatus 10, or may be separate from the information processing apparatus 10.

The communication module 25 connects to a communication network wirelessly or wired. The communication module 25 communicates various data with other devices connected to the communication network. The communication module includes, for example, a wireless local area network (LAN), which enables various data to be sent and received between devices according to a predetermined wireless communication method (for example, IEEE802.11).

The input/output interface 26 connects to various devices, including peripherals, by wired or wireless communication. The input/output interface 26 is, for example, a connector for wired data input/output according to the USB specification.

The camera 28 captures images including the image of a subject located in the field of view. The camera 28 outputs image data indicating the captured image obtained by the image capture to the processor 11 via the chipset 21.

The EC 31 is a one-chip microcomputer that monitors and controls various devices (peripherals, sensors, and the like) regardless of the operating state of the system of the information processing apparatus 10. Separately from the processor 11, the EC 31 has a CPU, a ROM, a RAM, multi-channel analog-to-digital (A/D) input pins, digital-to-analog (D/A) output pins, timers, and digital input/output pins (not illustrated). For example, the input device 32, the power circuit 33, and so on are connected to the input/output pins of the EC 31.

The input device 32 detects user operations and outputs operation signals in response to the detected operations to the EC 31. The above keyboard 107 and touchpad 109 correspond to the input device 32. The input device 32 may be a touch sensor, or may overlap with the display 14 and be configured as a touch panel. The input device 32 may have a dedicated button.

The power circuit 33 converts the voltage of DC power supplied from an external power supply or the battery 34 into a voltage required for operation of each device constituting the information processing apparatus 10, and supplies power having the converted voltage to a device to be supplied with the power. The power circuit 33 performs the power supply according to the control of the EC 31. The power circuit 33 includes a converter that converts the voltage of the power supplied to its own device and a power feeder that charges the battery 34 with the voltage-converted power. The power feeder charges the battery 34 with power that is left unconsumed by each device among the power supplied from the external power supply. When no power is supplied from the external power supply, or when the power supplied from the external power supply is insufficient, the power discharged from the battery 34 is supplied to each device as operating power.

The battery 34 charges or discharges power using the power circuit 33. The battery 34 may be, for example, any of a lithium-ion battery, a sodium-ion battery, and so on.

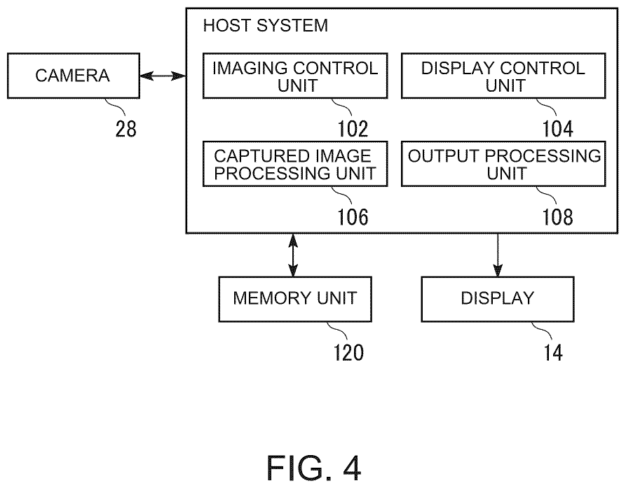

Subsequently, an example of the functional configuration of the electronic apparatus according to one or more embodiments is described. FIG. 4 is a schematic block diagram illustrating an example of a functional configuration of the electronic apparatus according to one or more embodiments. The information processing apparatus 10 includes a camera 28, a host system 100, a display 14, and a memory unit 120. Part or all of the functions of the host system 100 are performed by the processor 11, which executes application programs (sometimes referred to as “apps” in the present application), device drivers, and other programs on the OS, in cooperation with the main memory 12, the camera 28, the display 14, the memory unit 120, and other hardware.

The host system 100 has an imaging control unit 102, a display control unit 104, a captured image processing unit 106, and an output processing unit 108.

The imaging control unit 102 causes the camera 28 to capture an image on the basis of an imaging command input to the imaging control unit 102. The imaging command is, for example, given by an operation signal input from the input device 32 or input/output interface 26. The imaging command is also given by processing of other applications in some cases. The imaging command may be used to provide a direction of capturing a moving image or a still image.

In some cases, the imaging command includes an imaging parameter or the imaging parameter is input in association with the imaging command. The imaging parameter is, for example, any one or a combination of a focus distance, f-number, and the like. The imaging parameter for a moving image may include a frame rate. The imaging parameter for a still image may include exposure time (shutter speed). The imaging control unit 102 outputs an imaging command given by an operation signal to the camera 28 and to the captured image processing unit 106. The camera 28 captures an image according to the imaging command input from the imaging control unit 102. The camera 28 may control (automatic control) the imaging parameter according to the environment in the field of view using a known method. In such a case, the camera 28 may capture an image using its own defined imaging parameter and may notify the captured image processing unit 106 of the imaging parameter.

The display control unit 104 controls the display of display information based on display data on the display 14. The display information may be acquired by executing other programs (including applications). The display information corresponds to any one or a combination of characters, figures, symbols, and patterns. The display information is formed as a display screen and may be usually displayed over the transparent area TA and the normal area NA. The display control unit 104 displays the display information on the display 14 when acquiring the image captured by the camera 28 (referred to as “captured image” in the present application), and displays the display information when not acquiring the captured image.

The display control unit 104, for example, starts the repetition of the display and non-display periods that form the imaging cycle when detecting the input of an imaging synchronization signal (trigger) from the captured image processing unit 106. When detecting the input of the de-synchronization signal (trigger release) from the captured image processing unit 106, the display control unit 104 stops the repetition of the display and non-display periods and maintains the display of the display information. The imaging period of the camera 28 is included in the display period during which the display information is displayed, and is not included in the non-display period during which the display information is hidden.

The imaging cycle only needs to be sufficiently longer than the response time of a light emitting element and short enough that humans do not perceive temporal change in brightness due to blinking and perceive a state in which brightness is maintained at a constant level. The imaging cycle is, for example, 1/30 second or less. The imaging cycle is typically between 1 ms and 17 ms. When the captured image is a moving image, the imaging cycle may be equal to the frame cycle of the captured image or be an integer reciprocal multiple of the frame cycle. In that case, the display control unit 104 may control the repetition of the display and non-display periods on the basis of the frame synchronization signal related to image capture.

The display control unit 104 displays the display information on the display 14 during the display period. When displaying the display information, the display control unit 104 outputs a display start signal indicating the start of the display period to the display 14 at the start of each display period, for example. When detecting the display start signal, which is input from the display control unit 104, a timing controller (not illustrated) outputs drive signals to pixels placed in the screen area SA of the display 14. When not displaying the display information, the display control unit 104 outputs a display end signal, which indicates the end of the display period, to the display 14. When detecting the display end signal, which is input from the display control unit 104, the timing controller stops outputting drive signals to the pixels placed in the screen area SA of the display 14.

The captured image processing unit 106 monitors the input of a captured image signal from the camera 28 when the imaging command is input from the imaging control unit 102. The captured image processing unit 106 detects the start of image capture in the camera 28 by detecting the captured image signal. At this time, the captured image processing unit 106 outputs an imaging synchronization signal to the display control unit 104. In addition, the captured image processing unit 106 repeats the imaging and non-imaging periods for each predefined imaging cycle.

The captured image processing unit 106 adopts the captured image signal (captures), which is input from the timing controller of the camera 28 during the imaging period, and discards the captured image signal, which is input from the camera 28 during the non-imaging period. The captured image processing unit 106 accumulates the signal value for each pixel given by the captured image signal, which is input from the display control unit 104 for each imaging period, until the total acquisition time, which is the sum of the imaging periods, reaches the exposure time. The captured image processing unit 106 determines the accumulated value, which is obtained by accumulating the signal value for each pixel, as a signal value of the output image. The captured image processing unit 106 generates output image data indicating the output image and outputs the output image data to the output processing unit 108.

The output processing unit 108 performs processes related to outputting the output image data acquired from the captured image processing unit 106. The output processing unit 108 may output the output image data to other devices via the display 14 or the input/output interface 26, or may store the output image data in the memory unit 120. The output destination of the output image data may be indicated by an operation signal input from the input device 32 or the input/output interface 26, or by execution of other applications.

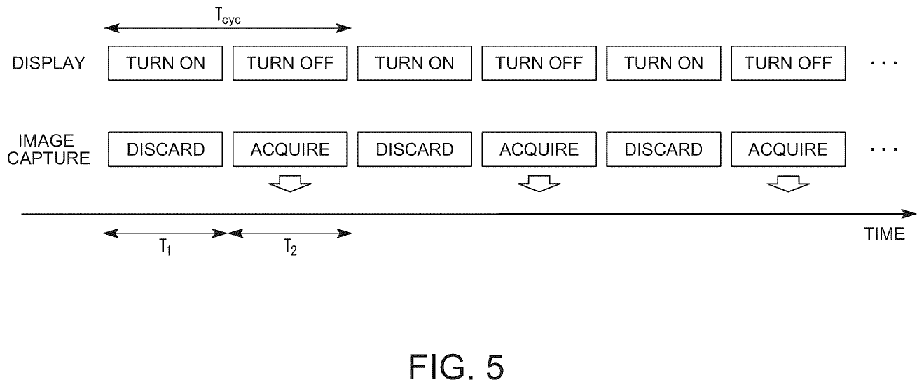

The following describes an example of synchronous control of display and imaging according to one or more embodiments. FIG. 5 is an explanatory diagram illustrating an example of synchronous control of display and imaging according to one or more embodiments. In the example of FIG. 5, after the imaging command is input to the imaging control unit 102, a display period T₁ and a non-display period T₂ are repeated for each imaging cycle T_{cyc}. In the display period T₁, the display control unit 104 displays the display information on the display 14 and discards the captured image taken by the camera 28.

More specifically, in the display period T₁, the timing controller of the display 14 supplies drive signals with power corresponding to the luminance that corresponds to per-pixel signal values representing the display information, which is input from the display control unit 104, and turns on the pixels placed in the transparent area TA. This display period T₁ is considered to be a non-imaging period, and the captured image processing unit 106 discards the captured image signal input from the camera 28.

During the non-display period T₂, the display control unit 104 acquires the captured image taken by the camera 28 without displaying on the display 14.

More specifically, in the non-display period T₂, the timing controller of the display 14 stops outputting drive signals to pixels and turns off the pixels placed in the transparent area TA. This non-display period T₂ is considered to be an imaging period, and the captured image processing unit 106 adopts the captured image signal acquired from the camera 28.

In the example of FIG. 5, the display period T₁ and the non-display period T₂ are equal to each other, but not limited thereto. The display period T₁ may be longer or shorter than the non-display period T₂.

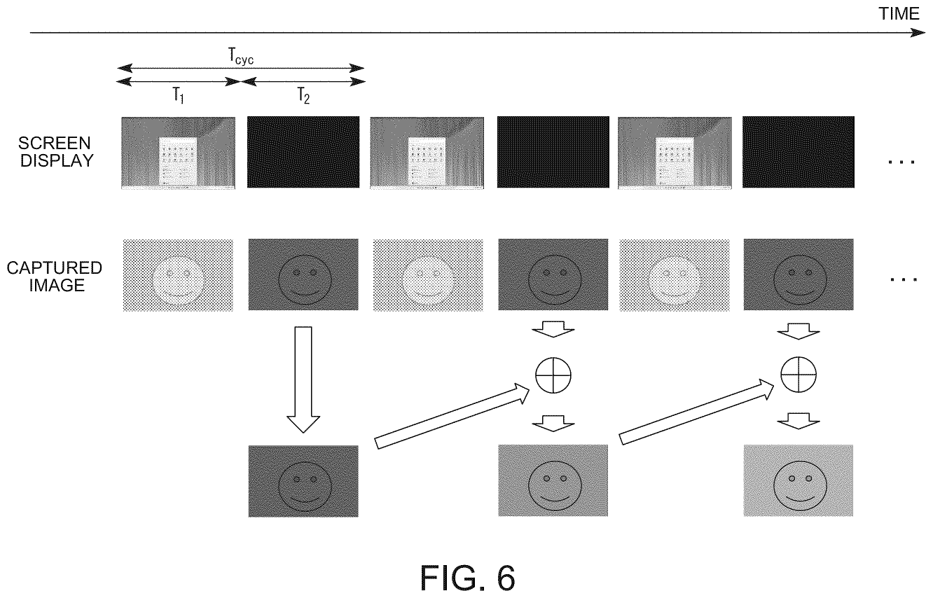

Next, description is made on an example of acquiring an output image according to one or more embodiments. FIG. 6 is an explanatory diagram illustrating an example of acquiring the output image according to one or more embodiments.

In the example of FIG. 6, during the display period T₁, there is displayed a display screen with a desktop screen superimposed on almost the center of the background screen as display information. The desktop screen is generally brighter than the background screen. The light of the pixels placed in the transparent area TA is incident on the camera 28 by the display on the display screen. The captured image taken during this period becomes brighter as a whole, decreases in contrast, and tends to have blurred outlines of individual objects.

In contrast, in the non-display period T₂, no display information is displayed on the display 14 and a black screen appears. The pixels placed in the transparent area TA do not emit light, and the light coming from the subject in the field of view is incident on the camera 28. The captured image taken during this period is not affected by the display. Since, however, the display period T₁ is shorter than the exposure time, the captured images acquired during each display period T₁ are generally darker. In one or more embodiments, the captured image processing unit 106 accumulates a signal value for each pixel given by the captured image signal acquired in each imaging period until the sum of imaging periods reaches the exposure time. The accumulated value, which is obtained by accumulating the signal values, is defined as a signal value of the output image, thereby enabling an acquisition of an output image with sufficient brightness without being affected by the display on the display 14.

When a moving image is included in the display image, a part of each frame cycle is set as the exposure time for each frame. Specifically, the captured image processing unit 106 accumulates a signal value for each pixel in each frame to compose an output image. The imaging cycle may be equal to the frame cycle of the display image or may be an integer reciprocal multiple of the frame cycle. In that case, the display control unit 104 may control the repetition of the display and non-display periods on the basis of the frame synchronization signal associated with the display information.

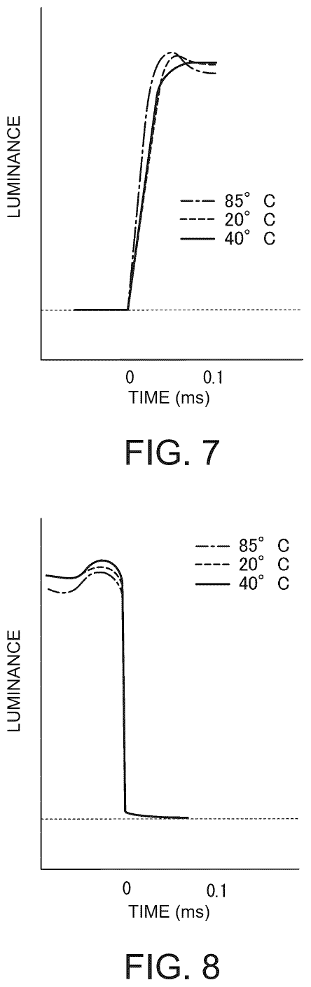

The screen area of the display 14 preferably has light emitting elements with high responsiveness to drive signals, such as OLEDs. According to the highly responsive light emitting elements, even when the imaging and non-imaging periods are set as non-display and display periods, respectively, without considering the response time, there will be no delay in the display on the display 14 or no afterimage to the captured image. FIGS. 7 and 8 illustrate temporal changes of luminance of OLEDs, respectively. FIG. 7 illustrates an example of starting the application of a voltage corresponding to a constant luminance to an OLED at time 0. In the example of FIG. 7, the luminance reaches its maximum value within 0.06 ms from the start of the voltage application for all of the temperatures of 20° C., 40° C., and 85° C. FIG. 8 illustrates an example of stopping the application of the voltage corresponding to the constant luminance to the OLED at time 0. In the example of FIG. 8, the luminance reaches almost zero immediately upon stopping the application of the voltage for all of the temperatures of 20° C., 40° C., and 85° C. Such characteristics allow the display 14 to sufficiently follow the switching of whether the display information needs to be displayed or not, even in the case where each single imaging period is set to a short period of about 1 ms.

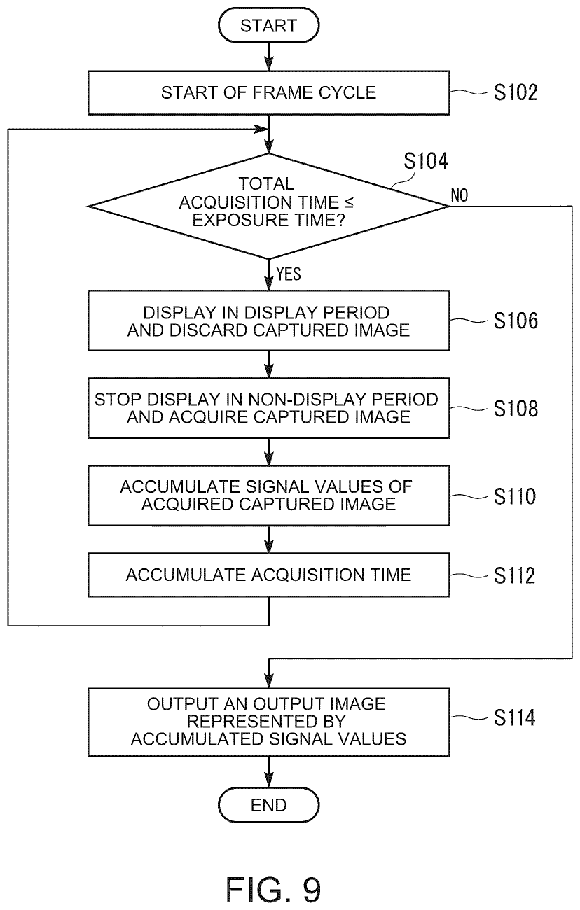

The following describes the procedure for imaging control according to one or more embodiments. FIG. 9 is a flowchart illustrating an imaging control process according to one or more embodiments. FIG. 9 illustrates an example of displaying a frame-by-frame display image, which is a moving image, as display information on the display 14. In the captured image processing unit 106, a period of time that forms a part of each frame cycle is preset in advance as exposure time for each frame cycle. In the example of FIG. 9, the imaging cycle that forms a frame cycle includes a display period and a non-display period in that order.

(Step S102) The captured image processing unit 106 detects the start of each frame cycle. For example, the captured image processing unit 106 determines the start of the frame cycle by detecting a predetermined frame synchronization signal associated with the display data. The captured image processing unit 106 also initializes the accumulated value and the total acquisition time for the signal value.

(Step S104) The captured image processing unit 106 determines whether the total acquisition time, which is the sum of the imaging periods in the frame cycle, is less than or equal to the exposure time. When the total acquisition time is determined to be less than or equal to the exposure time (YES in step S104), the control proceeds to step S106. When the total acquisition time is determined to exceed the exposure time (NO in step S104), the control proceeds to the process of step S114.

(Step S106) In the display period, the display control unit 104 displays the display information on the display 14. The captured image processing unit 106 discards the captured image signal, which is input from the camera 28.

(Step S108) In the non-display period, the display control unit 104 stops displaying the display information on the display 14. The captured image processing unit 106 acquires the captured image signal, which is input from the camera 28.

(Step S110) The captured image processing unit 106 updates the accumulated value by adding the signal value for each pixel indicated in the acquired captured image signal.

(Step S112) The captured image processing unit 106 updates the total acquisition time by adding the display period. Thereafter, the control returns to the process of step S104.

(Step S114) The captured image processing unit 106 generates an output image signal with the accumulated value of each pixel as a signal value, and outputs the output image signal to the output processing unit 108. Thereafter, the process of FIG. 8 is terminated.

The above description has been made mainly for the case where a moving image is displayed as display information on the display 14, but not limited thereto. The embodiments may be applied to a case where a still image is displayed. In such a case, the captured image processing unit 106 adopts, for example, the exposure time given by the imaging command, which is input from the imaging control unit 102. When the camera 28 determines the exposure time by automatic control, the captured image processing unit 106 may adopt the exposure time determined by the camera 28.

The display control unit 104 may control the display and non-display of the display information for each imaging cycle for the entire screen area SA of the display 14. In this case, the display information is displayed in the display period and not displayed in the non-display period for the entire screen area SA. The repetition frequency of blinking is equal for the entire screen area SA. Therefore, spatial bias of pixel degradation caused by blinking is avoided because blinking is not biased in a specific area (for example, the transparent area TA). This prevents burn-in, which is an unintended spatial change in luminance or color tone.

The display control unit 104 may limit the control of display and non-display of display information for each imaging cycle to the transparent area TA and does not have to apply the control to the normal area NA, which is the surrounding area. In this case, the display control unit 104 makes the luminance in the display period higher than the luminance in the normal area NA for the transparent area TA. At this time, the display control unit 104 causes the timing controller of the display 14 to drive the pixels placed in the transparent area TA so that the apparent luminance in the transparent area TA equals the luminance in the normal area NA. This compensates for the decrease in apparent luminance caused by blinking in the transparent area TA.

The controller of the camera 28 may perform imaging control during the non-display period of the display information to set the exposure time and other imaging parameters. In the imaging control, it is possible to avoid the influence of the emission of pixels placed in the transparent area TA during the display period. Therefore, for each imaging cycle, the display control unit 104 may output a display start signal, which indicates the start of the display period, to the camera 28, and may output a display end signal, which indicates the end of the display period, to the camera 28. The controller of the camera 28 is able to detect the start of the display period when the display start signal is input from the display control unit 104 and to detect the end of the display period when the display end signal is input.

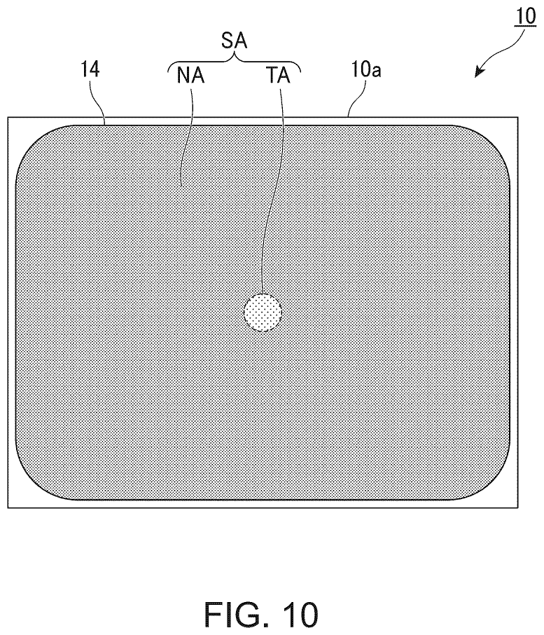

Although the transparent area TA is placed closer to one of the long sides than the center of the screen area of the display 14 in the examples of FIGS. 1 and 2, it is not limited thereto. As illustrated in FIG. 10, the transparent area TA may be placed at the center of the screen area of the display 14. With this placement, the image of the user's head facing the center of the display 14 is captured by the camera 28. The host system 100 executes a predetermined communication application, transmits the acquired output image to other information processing apparatuses, and displays the output images, which are acquired from other information processing apparatuses having similar configurations as to be included in the display information, on the display 14, thereby enabling users to communicate with each other through eye contact.

As described above, the electronic apparatus (for example, the information processing apparatus 10) according to one or more embodiments includes the display 14 having a screen area in which a plurality of pixels is arranged, the camera 28, the controller (for example, the host system 100, the timing controller). Light transmitted through the transparent area TA, which is a part of the screen area, is incident on the camera 28. The controller restricts the display in at least the transparent area TA when acquiring a captured image from the camera 28, and removes the restriction when not acquiring a captured image.

According to this configuration, the camera 28 is restricted in display at least in the transparent area TA when acquiring a captured image, and light from the subject penetrating the transparent area TA is incident on the camera 28. When not acquiring the captured image, the display in the transparent area TA is not restricted. Therefore, the screen area of the display 14 is able to be effectively used while avoiding degradation of image quality of the images captured by the camera 28.

The controller may also control whether it is necessary to display the pixels placed at least in the transparent area TA at each fixed imaging cycle, and may accumulate the signal values of the captured image for each non-display period that is included in the exposure period of the camera 28.

According to this configuration, the output image is obtained by the accumulated value, which is obtained by accumulating the signal values of the captured image taken at each imaging cycle that is subdivided into smaller periods than the exposure period. Subdividing the imaging cycle ensures substantially sufficient exposure for the imaging of the subject, without making the user aware of blinking of the display information at each imaging cycle.

The controller may also control whether the display is required for the entire screen area SA. According to this configuration, switching between the display and non-display of the display information is not limited to the transparent area TA, but extends to the entire screen area. The repetition frequency of pixel blinking is equal for the entire screen area SA, thereby enabling the bias of pixel degradation in a specific area (for example, the transparent area TA) to be avoided. Unintended spatial changes in luminance or color tone caused by uneven pixel degradation is able to be avoided.

Instead of controlling whether it is necessary to display the normal area NA, which is an area surrounding the transparent area TA, the controller may set the luminance for the transparent area TA in the display period of the display information to be higher than the luminance for normal area NA.

According to this configuration, the display information continues to be displayed in the normal area NA, and the display information blinks in the transparent area TA with a luminance higher than the luminance in the normal area NA. The increase in luminance compensates for the decrease in apparent luminance caused by blinking of the display information. This causes the luminance of the display information in the entire screen area of the display 14 to be uniform, thereby enabling a reduction or elimination in the discomfort of the user.

In addition, the camera 28 may control imaging conditions on the basis of incident light acquired during the non-display period of the display information.

According to this configuration, the camera 28 is able to control the imaging conditions by referring to the incident light in the non-display period, instead of referring to the incident light in the display period, in the control of the imaging conditions. In setting imaging parameters that indicate imaging conditions, it is possible to avoid the influence of light emission from pixels placed in the transparent area TA in the display period.

The electronic apparatus may also have the first chassis 10a, the second chassis 10b, and an engagement fixture (for example, hinge mechanisms 121a and 121b) that allows the first chassis 10a to rotatably engage the second chassis 10b. The display 14 may be installed on a surface facing the second chassis 10b in the first chassis 10a, and the transparent area TA may be installed in the center of the screen area of the display 14.

According to this configuration, when the electronic apparatus is used by a user with the first chassis 10a open against the second chassis 10b and facing the front of the first chassis 10a, the user is able to view the display information on the display 14 while the camera 28 is able to capture an image of the user's head. The captured images are sent and received to and from other electronic apparatuses and the captured images received from other electronic apparatuses are displayed as display information, thereby enabling the user to communicate with users of other electronic apparatuses through eye contact.

The embodiments of this disclosure have been described in detail with reference to the drawings. The specific configurations, however, are not limited to the embodiments described above, but also include designs and the like that do not depart from the gist of this disclosure. Each of the configurations described in the above embodiments may be combined arbitrarily.

### DESCRIPTION OF SYMBOLS

10 information processing apparatus
10a first chassis
10b second chassis
11 processor
12 main memory
13 video subsystem
14 display
14b substrate
14p pixel
21 chipset
22 ROM
23 auxiliary storage device
24 audio system
25 communication module
26 input/output interface
28 camera
31 EC
32 input device
33 power circuit
34 battery
100 host system
102 imaging control unit
104 display control unit
106 captured image processing unit
107 keyboard
108 output processing unit
109 touchpad
120 memory unit
121a, 121b hinge mechanism
ax rotation axis
NA normal area
TA transparent area
SA screen area

1. An electronic apparatus comprising:
a display having a screen area in which a plurality of pixels is arranged;
a camera; and
a controller, wherein
light transmitted through a transparent area, which is a part of the screen area, is incident on the camera, and
the controller restricts display at least in the transparent area when acquiring a captured image from the camera, and removes a restriction when not acquiring the captured image.

2. The electronic apparatus according to claim 1, wherein the controller controls whether display is required at least in the transparent area at each fixed imaging cycle and accumulates a signal value of a captured image for each non-display period included in an exposure period of the camera.

3. The electronic apparatus according to claim 2, wherein the controller controls whether the display is required for an entire screen area.

4. The electronic apparatus according to claim 2, wherein the controller does not control whether display is required for a standard area, which is an area surrounding the transparent area, and sets luminance of the transparent area in a display period to be higher than luminance of the standard area.

5. The electronic apparatus according to claim 2, wherein the camera controls imaging conditions in the non-display period for the transparent area.

6. The electronic apparatus according to claim 1, wherein
the electronic apparatus has a first chassis, a second chassis, and an engagement fixture that allows the first chassis to be rotatably engaged with the second chassis, and
the display is installed on a surface facing the second chassis in the first chassis and the transparent area is installed in a center of the screen area.

7. A control method for an electronic apparatus that includes a display having a screen area in which a plurality of pixels is arranged, a camera, and a controller, in which light transmitted through a transparent area, which is a part of the screen area, is incident on the camera, wherein
the electronic apparatus restricts display at least in the transparent area when acquiring a captured image from the camera, and removes a restriction when not acquiring the captured image.
